(19) United States
(12) Patent Application Publication
(10) Pub. No.: US 2017/0353090 A1
(43) Pub. Date: Dec. 7, 2017

(54) STATOR UNIT, MOTOR, AND BLOWER

(71) Applicant: Nidec Corporation, Kyoto (JP)

(72) Inventors: Hitoshi TAKAKI, Kyoto (JP); Tadayuki KANATANI, Kyoto (JP)

(21) Appl. No.: 15/613,479

(22) Filed: Jun. 5, 2017

(30) Foreign Application Priority Data
Jun. 7, 2016 (JP) 2016-113586

(51) Int. Cl. H02K 15/03; H02K 5/173; H02K 5/10; H02K 5/16; F16C 35/02; H02K 5/08

(52) U.S. Cl. CPC H02K 15/03; H02K 5/1732; H02K 5/10; F16C 35/02; H02K 5/08; H02K 5/16

(57) ABSTRACT

A stator unit includes a base member including a bearing housing extending along a rotation axis, a stator fixed to an outer circumferential surface of the bearing housing, and a molding resin part covering the stator. The stator includes a stator core having teeth protruding radially outward, an insulator for partially covering a surface of the stator core, and coils. A non-sealed space connected to an external space of the stator unit and a sealed space connected to an internal space of the stator unit are opposed through a contact location where the bearing housing or the base member makes contact with the molding resin part or the insulator. An angle α of the non-sealed space and an angle β of the sealed space opposed to each other through the contact location in a cross section including the rotation axis are set to satisfy a relationship of α>β.

### CROSS REFERENCE TO RELATED APPLICATIONS

This application claims the benefit of priority to Japanese Patent Application No. 2016-113586 filed on Jun. 7, 2016. The entire contents of this application are hereby incorporated herein by reference.

### BACKGROUND OF THE INVENTION

1. Field of the Invention

The present invention relates to a stator unit, a motor, and a blower.

2. Description of the Related Art

Conventionally, there is known a molded motor in which a winding wound around a stator core and a bush mounting portion having a leg provided on the stator core are molded and solidified with a thermosetting resin. The molded motor is excellent in waterproof property and vibration proofing/soundproofing property at the time of driving the motor. A conventional molded motor is described in, for example, Japanese Patent Laid-Open Publication No. S59-70163.

Further, in a motor used for a communication base station with a high possibility of being exposed to the ambient air or a home electric appliance such as a refrigerator or the like, it is required to satisfy a higher waterproof standard such as a salt spray test or the like. For example, Japanese Patent Laid-Open Publication No. H07-59289 discloses a motor with higher sealability.

However, in the structure of Japanese Patent Laid-Open Publication No. H07-59289, it is necessary to further use a separate member such as an O ring or a sealing material. This may make the manufacturing process more complicated and may increase the manufacturing cost.

An object of the present invention is to provide a molded motor capable of enjoying high waterproof performance without using a separate member in a stator unit used for the molded motor.

### SUMMARY OF THE INVENTION

In accordance with an aspect of the present invention, there is provided a stator, including: a base member including a cylindrical bearing housing extending along a vertically extending rotation axis; a stator fixed to an outer circumferential surface of the bearing housing; and a molding resin part arranged to cover the stator, wherein the stator includes a stator core having a plurality of teeth protruding radially outward, an insulator arranged to cover a part of a surface of the stator core, and a plurality of coils including conductive wires wound around the teeth via the insulator, a non-sealed space connected to an external space of the stator unit and a sealed space connected to an internal space of the stator unit are opposed to each other through a contact location where the bearing housing or the base member makes contact with the molding resin part or the insulator, and an angle α of the non-sealed space and an angle β of the sealed space opposed to each other through the contact location in a cross section including the rotation axis are set to satisfy a relationship of α>β.

According to the first exemplary embodiment of the present invention, the non-sealed space connected to the external space of the stator unit and the sealed space connected to the internal space of the stator unit are opposed to each other through the contact location where the bearing housing or the base member makes contact with the molding resin part or the insulator. Thus, if the angle α of the non-sealed space and the angle β of the sealed space opposed to each other through the contact location in the cross section including the rotation axis are set to satisfy a relationship of α>β, it is possible to prevent water droplets from entering the inside.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a vertical sectional view of a motor according to a first embodiment.

FIGS. 2 and 3 are partial vertical sectional views of the motor according to the first embodiment.

FIG. 4 is a vertical sectional view of a motor according to a second embodiment.

FIG. 5 is a vertical sectional view of a motor according to a third embodiment.

FIG. 6 is a partial vertical sectional view of a motor according to a modification.

FIG. 7 is a partial vertical sectional view of a motor according to another modification.

### DETAILED DESCRIPTION OF THE PREFERRED EMBODIMENTS

Exemplary preferred embodiments of the present invention will now be described with reference to the drawings. In the present invention, the direction parallel to the rotation axis of a motor including a stator unit will be referred to as “axial direction”, the direction orthogonal to the rotation axis of the motor will be referred to as “radial direction”, and the direction along the circular arc about the rotation axis of the motor will be referred to as “circumferential direction”. Furthermore, in the present invention, the shapes and arrangement relationships of the respective parts will be described under the assumption that the axial direction is a vertical direction and the circuit board side with respect to a stator is a lower side. However, the definition of the vertical direction is not intended to limit the orientation of the motor according to the present invention at the time of manufacture and using the same.

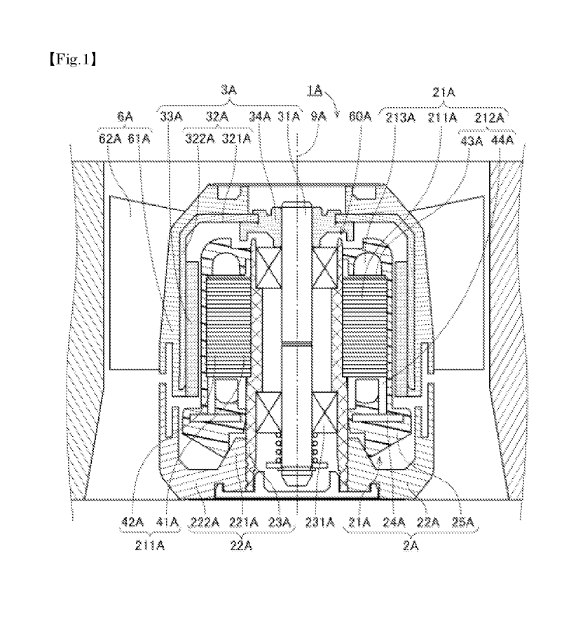

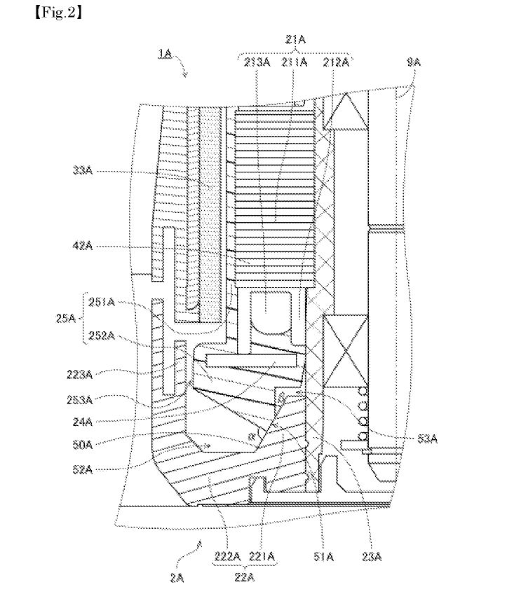

FIG. 1 is a vertical sectional view of a motor 1A including a stator unit 2A according to a first embodiment of the present invention. FIG. 2 is a partial vertical sectional view of a cross section including a rotation axis 9A of a motor 1A.

The motor 1A is used as, for example, a blower for supplying a cooling air flow in a home base electric appliance such as a refrigerator or the like, or a communication base station in which a plurality of electronic devices are arranged. The motor 1A preferably includes an impeller 6A having a plurality of blades 62A. However, the motor 1A of the present invention may not include the impeller 6A.

As shown in FIG. 1, the motor 1A preferably includes a stator unit 2A and a rotor unit 3A. The rotor unit 3A is rotatably supported with respect to the stator unit 2A. In addition, the rotor unit 3A rotates about a rotation axis 9A extending in a vertical direction.

The stator unit 2A preferably includes a stator 21A, a base member 22A, a circuit board 24A, and a molding resin part 25A. The base member 22A preferably includes a bearing housing 23A, a base protruding portion 221A, and a base bottom plate portion 222A. The inner circumferential surface of the base protruding portion 221A extends in a cylindrical shape along the rotation axis 9A. The base bottom plate portion 222A extends radially outward from the lower end of the base protruding portion 221A. The stator 21A is an armature fixed to the outer circumferential surface of the bearing housing 23A.

The bearing housing 23A of the present embodiment is a cylindrical member extending along the vertically-extending rotation axis 9A. The lower portion of the bearing housing 23A is fixed to the inner circumferential surface of the base member 22A by, for example, an adhesive agent. A bearing unit 231A is disposed radially inward of the bearing housing 23A. For example, a ball bearing is used for the bearing unit 231A. The outer ring of the bearing unit 231A is fixed to the inner circumferential surface of the bearing housing 23A. The inner race of the bearing unit 231A rotatably supports a below-described shaft 31A. Thus, the shaft 31A is rotatably supported with respect to the base member 22A. However, instead of the ball bearing, the motor 1A may include another type of bearing unit such as a sliding bearing, a fluid bearing, or the like. In the present embodiment, the bearing housing 23A is formed of a member different from the base member 22A. However, the bearing housing 23A and the base member 22A may be formed of a single member.

The rotor unit 3A preferably includes a shaft 31A, a rotor holder 32A, a plurality of magnets 33A, and an annular member 34A. The shaft 31A is a columnar member arranged along the rotation axis 9A. At least a part of the shaft 31A is disposed radially inward of the bearing housing 23A. The shaft 31A is rotatably supported by the base member 22A via the bearing unit 231A.

As the material of the rotor holder 32A, for example, a metal such as iron or the like which is a magnetic material is used. The rotor holder 32A preferably includes a holder top plate portion 321A and a holder cylindrical portion 322A. The holder top plate portion 321A extends substantially perpendicularly to the rotation axis 9A. The central portion of the holder top plate portion 321A is fixed to the shaft 31A via the annular member 34A. As a result, the rotor holder 32A rotates together with the shaft 31A. The holder cylindrical portion 322A extends in a cylindrical shape from the outer peripheral portion of the holder top plate portion 321A toward the lower side in the axial direction.

As shown in FIG. 1, the motor 1A of the present embodiment preferably includes an impeller 6A for use as a blower that supplies an air flow. The impeller 6A preferably includes an impeller cup 61A and a plurality of blades 62A. The impeller cup 61A is fixed to the rotor holder 32A. The blades 62A extend radially outward from the outer circumferential surface of the impeller cup 61A. When driving the motor 1A, the impeller 6A rotates together with the rotor holder 32A and the shaft 31A. The blades 62A are arranged at substantially equal intervals in the circumferential direction. The number of the blades is not particularly limited.

The magnets 33A are disposed on the inner circumferential surface of the holder cylindrical portion 322A. The radial inner surfaces of the magnets 33A are magnetic pole surfaces radially opposed to the radial outer end surfaces of teeth 42A. The magnets 33A are arranged at equal intervals in the circumferential direction so that the magnetic pole surfaces having an N pole and the magnetic pole surfaces having an S pole are alternately arranged.

Instead of the magnets 33A, a single annular magnet may be used. When the annular magnet is used, the N pole and the S pole may be alternately magnetized in the circumferential direction on the inner circumferential surface of the annular magnet. Further, the magnets may be embedded in the rotor holder 32A. In addition, the rotor holder 32A may be molded with a resin mixed with a magnetic material powder. The rotor holder 32A may be fixed to the shaft 31A.

The stator 21A is an armature that generates a magnetic flux in response to a drive current. The stator 21A preferably includes a stator core 211A, an insulator 212A, and a plurality of coils 213A. The stator core 211A is formed of a laminated steel plate in which electromagnetic steel plates are laminated in the axial direction. The stator core 211A preferably includes an annular core back 41A surrounding the rotation shaft 9A and a plurality of teeth 42A protruding radially outward from the core back 41A. The teeth 42A are arranged at equal intervals in the circumferential direction.

The insulator 212A covers at least a part of the surface of the stator core 211A. As the material of the insulator 212A, a resin of an insulating material is used. The insulator 212A preferably includes an upper insulator 43A covering the upper portion of the stator core 211A and a lower insulator 44A covering the lower portion of the stator core 211A. In addition, the coils 213A preferably include conductive wires wound around the teeth 42A via the insulator 212A.

The circuit board 24A is electrically connected to the stator 21A. The circuit board 24A is disposed substantially perpendicularly to the rotation axis 9A on the lower side of the stator 21A. An electric circuit for supplying a drive current to the coils 213A is mounted on the circuit board 24A. The end portions of the conductive wires constituting the coils 213A are electrically connected to the electric circuit on the circuit board 24A. A current supplied from an external power source flows to the coils 213A via the circuit board 24A.

The molding resin part 25A is a resin-made member covering at least a part of the stator 21A and the circuit board 24A. For example, a thermosetting unsaturated polyester resin is used as the material of the molding resin part 25A. The molding resin part 25A is obtained by pouring a resin into a cavity of a mold in which the stator 21A and the circuit board 24A are accommodated, and curing the resin.

As shown in FIG. 2, the molding resin part 25A of the present embodiment preferably includes a molding resin cylindrical portion 251A and a molding resin bottom portion 252A. The molding resin cylindrical portion 251A extends in a substantially cylindrical shape in the axial direction. The stator 21A is covered with the resin which forms the molding resin cylindrical portion 251A. However, a part of the stator 21A including the radial outer end surfaces of the teeth 42A may be exposed from the molding resin cylindrical portion 251A. The magnets 33A of the rotor unit 3A are disposed radially outward of the molding resin cylindrical portion 251A. For example, the molding resin bottom portion 252A bulges radially outward in the lower end portion of the molding resin cylindrical portion 251A. In the present embodiment, the outer diameter of the circuit board 24A is larger than the outer diameter of the teeth 42A. A part of the radial outer portion of the circuit board 24A axially overlaps with the magnets 33A. Therefore, when the circuit board 24A is covered with the molding resin part 25A, the molding resin bottom portion 252A is arranged axially lower than the magnets 33A.

As described above, the circuit board 24A is covered with the molding resin part 25A. As a result, it is possible to suppress entry of water droplets into the circuit board 24A. Moreover, it is possible to prevent occurrence of a short circuit between the terminals on the circuit board 24A.

A gap 253A narrower than the periphery is formed between the radial outer surface of the molding resin bottom portion 252A and the radial inner surface of a base protrusion 223A extending axially upward from the base bottom plate portion 222A. As a result, it is possible to suppress entry of water droplets into the inside of the stator unit 2A. In addition, a labyrinth structure may be formed by at least a part of the narrow gap 253A. As used herein, the term “labyrinth structure” refers to a structure in which intricate gaps are provided between two opposing members by forming the two opposing members in a convex shape and a concave shape. This makes it possible to further suppress entry of water droplets through the gap 253A.

In the manufacturing process of the motor 1A, the molding resin part 25A is formed by supplying a resin to around the stator 21A and the circuit board 24A at once. Thus, it is possible to enhance the productivity. The molding resin part 25A may further have a structure that covers at least a part of the bearing housing 23A.

At the time of driving the motor 1A, a drive voltage is supplied from an external power source to the coils 213A via the circuit board 24A. As a result, a magnetic flux is generated in the teeth 42A of the stator core 211A. Then, a circumferential torque is generated by the action of the magnetic flux between the teeth 42A and the magnets 33A. As a result, the rotor unit 3A rotates about the rotation axis 9A.

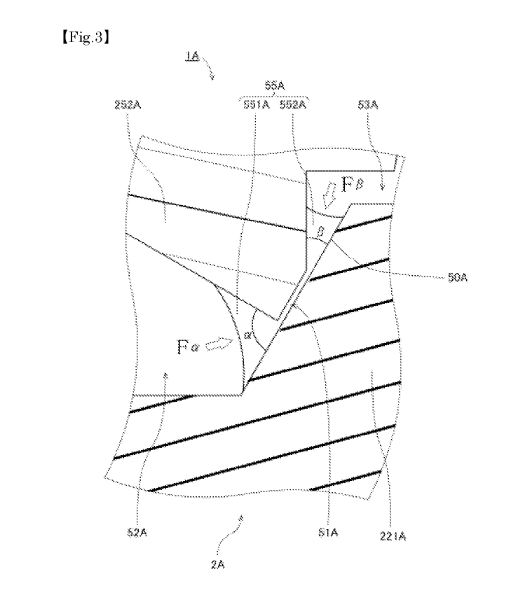

Subsequently, the structure of the contact location between the base member 22A and the molding resin part 25A according to the present embodiment will be described. FIGS. 2 and 3 are partial vertical sectional views of a cross section including the rotation axis 9A of the motor 1A.

As shown in FIG. 2, the base protruding portion 221A of the base member 22A preferably includes a conical inclined surface inclined with respect to the radial direction and extending away from the stator core 211A as going radially outward. The molding resin bottom portion 252A of the molding resin part 25A is bent in the radial direction by coming into contact with the inclined surface 50A. A non-sealed space 52A connected to the external space of the stator unit 2A and a sealed space 53A connected to the internal space of the stator unit 2A are opposed to each other through a contact location 51A. Instead of the molding resin part 25A or in addition to the molding resin part 25A, the insulator 212A may make contact with the inclined surface 50A of the base protruding portion 221A. The term “sealed space” includes a case where the sealed space is completely sealed and not connected to the external space at all and a case where the sealed space is slightly connected to the external space via a minute gap described later or the like. A space which does not correspond to the “sealed space”, namely a space which is completely connected to the external space, is defined as “non-sealed space”.

As shown in FIG. 3, at the contact location 51A, a minute gap may be generated between the molding resin bottom portion 252A and the base protruding portion 221A. In the present embodiment, not only a case where a gap is not formed due to complete contact but also a case where such a small gap is formed will be referred to as “contact”. In FIG. 3, an angle α of the non-sealed space 52A and an angle β of the sealed space 53A opposed to each other through the contact location 51A satisfy a relationship of α>β. Specifically, the angle α is an angle formed between the molding resin bottom portion 252A and the base protruding portion 221A in a portion of the non-sealed space 52A adjacent to the contact location 51A. Specifically, the angle β is an angle formed between the molding resin bottom portion 252A and the base protruding portion 221A in a portion of the sealed space 53A adjacent to the contact location 51A.

In this situation, description will be made on a phenomenon occurring when water droplets intrude from the external space of the stator unit 2A through the contact location 51A, namely when water droplets 55A intrude from the side of the non-sealed space 52A connected to the external space of the stator unit 2A into the sealed space 53A connected to the internal space of the stator unit 2A, via the gap of the contact location 51A.

In FIG. 3, among the intruding water droplets 55A, a water droplet 551A existing on the side of the non-sealed space 52A and a water droplet 552A existing on the side of the sealed space 53A are respectively applied with a force Fα and a force Fβ that draw the water droplet 551A and the water droplet 552A toward the minute gap of the contact location 51A. These forces are forces generated due to the so-called “capillary phenomenon”.

The force Fα is a force by which the water droplet 551A existing on the side of the non-sealed space 52A tries to climb up the gap of the contact location 51A. The force Fβ is a force by which the water droplet 552A existing on the side of the sealed space 53A tries to go down along the gap of the contact location 51A. The forces Fα and Fβ act in the opposite directions with respect to the water droplet 552A.

The “capillary phenomenon” is influenced by the surface tension, the density, the size of a gap, and the like. The water droplet 551A existing on the side of the non-sealed space 52A and the water droplet 552A existing on the side of the sealed space 53A are not different in physical properties, are arranged in substantially the same manner and are opposed to each other via the common gap of the contact location 51A. Therefore, in addition to the angles α and β opposed to each other via the gap of the contact location 51A, the numerical values that affect the force Fα and the force Fβ are equal to each other. In general, the smaller the size of the gap, the larger the force of drawing the water droplet into the gap by the “capillary phenomenon”. Since the angle α of the non-sealed space 52A is larger than the angle β of the sealed space 53A, the size of the gap is smaller on the side of the sealed space 53A than on the side of the non-sealed space 52A.

Therefore, the force Fβ applied to the water droplet 552A existing on the side of the sealed space 53A is larger than the force Fα applied to the water droplet 551A existing on the side of the non-sealed space 52A. Accordingly, even if the water droplet 55A tries to enter the sealed space 53A from the side of the non-sealed space 52A, the water droplet 55A is pushed back. This makes it possible to suppress the entry of water droplets into the sealed space 53A from the outside of the stator unit 2A, namely the entry of water droplets into the inside of the motor 1A including the stator unit 2A.

When the molding resin bottom portion 252A and the base protruding portion 221A make complete contact with each other at the contact location 51A so that no minute gap is generated, needless to say, it is possible to prevent the entry of water droplets from the outside of the stator unit 2A, namely the entry of water droplets into the motor 1A.

At the contact location 51A, the molding resin bottom portion 252A of the molding resin part 25A and the base protruding portion 221A of the base member 22A make surface-to-surface contact with each other over the entire circumference around the rotation axis 9A. This makes it possible to further stabilize the contact state. Instead of the molding resin part 25A, the insulator 212A may make surface-to-surface contact with the base member 22A.

In addition, the molding resin part 25A and the insulator 212A are made of a resin having elasticity. Thus, it is easy to maintain the contact state with the base member 22A, whereby the waterproofness is enhanced.

Furthermore, the motor 1A of the present embodiment preferably includes an annular labyrinth structure 60A disposed in at least a part of the space surrounded by the bearing housing 23A, the rotor holder 32A and the molding resin part 25A. By providing the labyrinth structure 60A, it is possible to suppress the radially inward entry of water droplets in the space between the rotor unit 3A and the stator unit 2A. Accordingly, it is possible to suppress the entry of water droplets into the rotor unit 3A and to further enhance the waterproofness of the motor 1A.

Moreover, as described above, the rotor unit 3A of the present embodiment preferably includes an annular member 34A arranged to connect the shaft 31A and the rotor holder 32A. The labyrinth structure 60A is provided in at least a part of the space surrounded by the annular member 34A, the bearing housing 23A, the rotor holder 32A and the molding resin part 25A. More specifically, an intricate gap is provided between the protrusions provided in the annular member 34A and the recesses provided in the molding resin part 25A. As a result, it is possible to suppress the entry of water droplets into the rotor unit 3A and to enhance the waterproofness of the motor 1A.

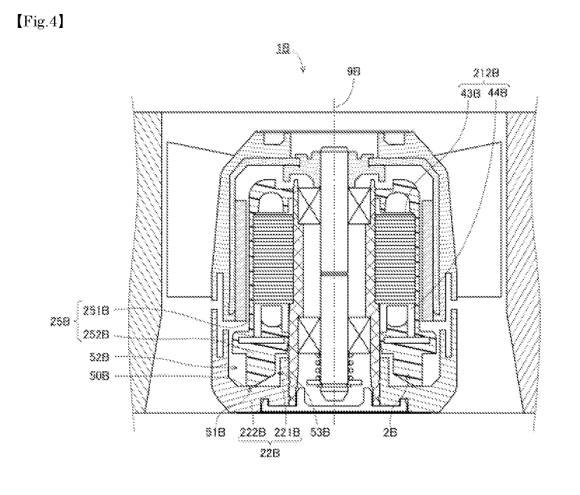

Subsequently, a second embodiment of the present invention will be described. FIG. 4 is a vertical sectional view of a motor 1B including a stator unit 2B according to the second embodiment. In the following description, differences from the first embodiment will be mainly described. Redundant description will be omitted for the parts equivalent to those of the first embodiment and the parts already described in the first embodiment.

As shown in FIG. 4, the base member 22B preferably includes a base protruding portion 221B protruding in the axial direction and a base bottom plate portion 222B. The base protruding portion 221B extends in a cylindrical shape along the rotation axis 9B. The base bottom plate portion 222B extends radially outward from the lower end portion of the base protruding portion 221B.

Furthermore, the base bottom plate portion 222B of the base member 22B preferably includes a planar surface 50B extending perpendicularly to the rotation axis 9B. The molding resin bottom portion 252B of the molding resin part 25B makes contact with the planar surface 50B. Moreover, a non-sealed space 52B connected to the external space of the stator unit 2B and a sealed space 53B connected to the internal space of the stator unit 2B are opposed to each other through a contact location 51B. Similar to the first embodiment, the angle of the non-sealed space 52B opposed to the sealed space 53B through the contact location 51B is made larger than the angle of the sealed space 53B. Thus, it is possible to suppress the entry of water droplets into the sealed space 53B from the outside of the stator unit 2B, namely the entry of water droplets into the motor 1B including the stator unit 2B. Instead of the molding resin part 25B, an insulator 212B may make contact with the planar surface 50B.

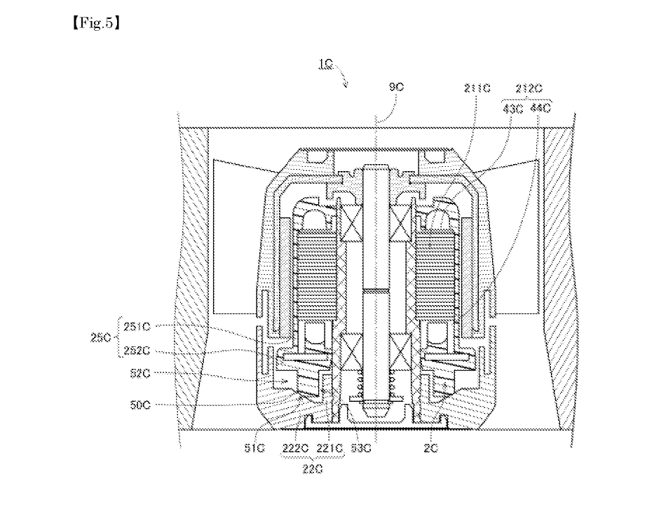

Subsequently, a third embodiment of the present invention will be described. FIG. 5 is a vertical sectional view of a motor 1C including a stator unit 2C according to the third embodiment. In the following description, differences from the above-described embodiments will be mainly described. Redundant description will be omitted for the parts equivalent to those of the above-described embodiments and the parts already described in the above-described embodiments.

As shown in FIG. 5, the base member 22C preferably includes a base protruding portion 221C protruding in the axial direction and a base bottom plate portion 222C. The base protruding portion 221C extends in a cylindrical shape along the rotation axis 9C. The base bottom plate portion 222C extends radially outward from the lower end portion of the base protruding portion 221C.

Furthermore, the base bottom plate portion 222C of the base member 22C preferably includes a conical inclined surface 50C inclined with respect to the radial direction and extending away from the stator core 211C as going radially inward. The molding resin bottom portion 252C of the molding resin part 25C makes contact with the inclined surface 50C. Moreover, a non-sealed space 52C connected to the external space of the stator unit 2C and a sealed space 53C connected to the internal space of the stator unit 2C are opposed to each other through a contact location 51C. As in the first embodiment, the angle of the non-sealed space 52C opposed to the sealed space 53C through the contact location 51C is made larger than the angle of the sealed space 53. Thus, it is possible to suppress the entry of water droplets into the sealed space 53C from the outside of the stator unit 2C, namely the entry of water droplets into the motor 1C including the stator unit 2C. Instead of the molding resin part 25C, an insulator 212C may make contact with the inclined surface 50C.

While exemplary embodiments of the present invention have been described above, the present invention is not limited to the above-described embodiments.

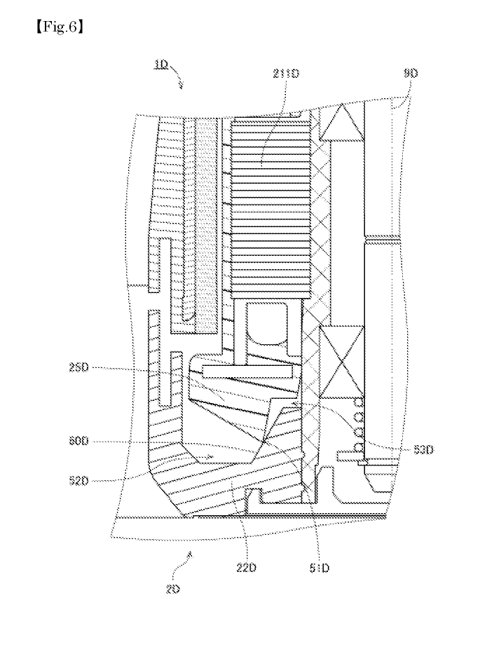

FIG. 6 is a partial vertical sectional view of a cross section including a rotation shaft 9D of a motor 1D according to a modification. In the example of FIG. 6, the molding resin part 25D and the base member 22D make line-to-line contact with each other over the entire circumference around the rotation axis 9D at the contact location 51D. Thus, even if the thin molding resin part 25D is used, a contact structure can be formed and the cost can be reduced. In FIG. 6, the base member 22D preferably includes a conical inclined surface 50D inclined with respect to the radial direction and extending away from the stator core 211D as going radially outward. The molding resin part 25D comes into contact with the inclined surface 50D in a radially deflected state. A non-sealed space 52D connected to the external space of the stator unit 2D and a sealed space 53D connected to the internal space of the stator unit 2D are opposed to each other through the contact location 51D.

The molding resin part or the insulator may make contact with the bearing housing. For example, the non-sealed space connected to the external space of the stator unit and the sealed space connected to the internal space of the stator unit are opposed to each other through the contact location between the molding resin part or the insulator and the bearing housing. The angle α of the non-sealed space and the angle β of the sealed space opposed to each other may satisfy a relationship of α>β. Even with such a structure, it is possible to suppress the entry of water droplets into the motor including the stator unit.

Furthermore, the molding resin part or the insulator and the bearing housing may make surface-to-surface contact or line-to-line contact with each other over the entire circumference around the rotation axis.

Moreover, in the bearing housing, an inclined surface inclined with respect to the radial direction or a planar surface extending perpendicularly to the rotation axis may be provided. The molding resin part or the insulator may come into contact with the inclined surface or the planar surface. The non-sealed space connected to the external space of the stator unit and the sealed space connected to the internal space of the stator unit may be opposed to each other through the contact location.

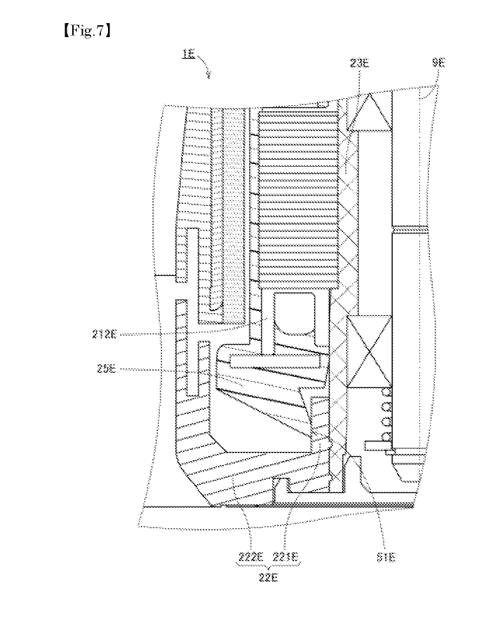

FIG. 7 is a partial vertical sectional view of a cross section including a rotation axis 9E of a motor 1E according to another modification. In FIG. 7, the base member 22E preferably includes a base protruding portion 221E protruding in the axial direction and a base bottom plate portion 222E extending radially outward from the lower end portion of the base protruding portion 221E. At the contact location 51E, the molding resin part 25E makes contact with the base protruding portion 221E of the base member 22E. Instead of the molding resin part 25E, the insulator 212E may make contact with the base protruding portion 221E. In addition, it may be possible to employ a structure in which the molding resin part 25E or the insulator 212E makes contact with a protruding portion provided in the bearing housing 23E.

The bearing housing or the base member may be made of a metal or a resin. It is possible to secure high strength when the bearing housing or the base member made of a metal makes contact with the molding resin part or the insulator made of a resin at the aforementioned contact location. In addition, when the bearing housing or the base member made of a resin makes contact with the molding resin part or the insulator made of a resin, the contact state can be maintained with ease, and the waterproofness can be enhanced.

The present invention can be applied to, for example, a stator unit, a motor, and a blower.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A stator unit, comprising:
a base member including a cylindrical bearing housing extending along a vertically extending rotation axis;
a stator fixed to an outer circumferential surface of the bearing housing; and
a molding resin part arranged to cover the stator,
wherein the stator includes a stator core having a plurality of teeth protruding radially outward, an insulator arranged to cover a part of a surface of the stator core, and a plurality of coils including conductive wires wound around the teeth via the insulator,
a non-sealed space connected to an external space of the stator unit and a sealed space connected to an internal space of the stator unit are opposed to each other through a contact location where the bearing housing or the base member makes contact with the molding resin part or the insulator, and
an angle α of the non-sealed space and an angle β of the sealed space opposed to each other through the contact location in a cross section including the rotation axis are set to satisfy a relationship of α>β.

2. The stator unit of claim 1, wherein at the contact location, the bearing housing or the base member makes surface-to-surface contact with the molding resin part or the insulator.

3. The stator unit of claim 1, wherein at the contact location, the bearing housing or the base member makes line-to-line contact with the molding resin part or the insulator.

4. The stator unit of claim 1, wherein at the contact location, the base member makes contact with the molding resin part.

5. The stator unit of claim 1, wherein at the contact location, the bearing housing makes contact with the molding resin part.

6. The stator unit of claim 1, wherein the base member or the bearing housing includes an inclined surface inclined with respect to a radial direction, and
the molding resin part or the insulator makes contact with the inclined surface at the contact location.

7. The stator unit of claim 6, wherein the inclined surface is a conical surface extending away from the stator core as going radially outward.

8. The stator unit of claim 6, wherein the molding resin part or the insulator makes contact with the inclined surface in a radially deflected state.

9. The stator unit of claim 1, wherein the base member or the bearing housing includes a planar surface extending perpendicularly to the rotation axis, and
the molding resin part or the insulator makes contact with the planar surface at the contact location.

10. The stator unit of claim 1, wherein the base member or the bearing housing includes a protruding portion protruding in an axial direction, and
the molding resin part or the insulator makes contact with the protruding portion at the contact location.

11. The stator unit of claim 1, wherein the bearing housing or the base member is made of a metal,
the molding resin part or the insulator is made of a resin, and
the bearing housing or the base member made of the metal makes contact with the molding resin part or the insulator made of the resin at the contact location.

12. The stator unit of claim 1, wherein the bearing housing or the base member is made of a resin,
the molding resin part or the insulator is made of a resin, and
the bearing housing or the base member made of the resin makes contact with the molding resin part or the insulator made of the resin at the contact location.

13. The stator unit of claim 1, wherein the molding resin part is arranged to further cover a part of the bearing housing.

14. The stator unit of claim 1, wherein a labyrinth structure is provided in at least a part of a gap where the molding resin part and the base member face each other.

15. A motor, comprising:
the stator unit of claim 1; and
a rotor unit rotatably supported by a bearing held in the bearing housing.

16. The motor of claim 15, wherein the rotor unit includes a magnet, a rotor holder arranged to support the magnet, and a shaft at least partially arranged in the bearing housing, and
a labyrinth structure is provided in at least a part of a space surrounded by the bearing housing, the rotor holder and the molding resin part.

17. The motor of claim 16, wherein the rotor unit further includes an annular member arranged to connect the shaft and the rotor holder, and
a labyrinth structure is provided in at least a part of a space surrounded by the annular member, the bearing housing, the rotor holder and the molding resin part.

18. A blower, comprising:
the motor of claim 16; and
an impeller including an impeller cup fixed to the rotor holder and a plurality of blades extending radially outward from the impeller cup.
